(19) United States
(12) Patent Application Publication
(10) Pub. No.: US 2011/0007225 A1
(43) Pub. Date: Jan. 13, 2011

(54) TUNER UNIT AND FLAT-SCREEN TELEVISION RECEIVER

(75) Inventor: Masanori Kitaguchi, Osaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 12/833,031

(22) Filed: Jul. 9, 2010

(30) Foreign Application Priority Data
Jul. 10, 2009 (JP) 2009-162417

(51) Int. Cl. H04N 5/50

(52) U.S. Cl. 348/731; 348/E05.097

(57) ABSTRACT

Provided is a tuner unit, including: a shield case (31) including a plurality of side walls surrounding a circuit board (2) on which an electronic component (21) is mounted, and a flat plate portion (314) that is integrated with at least one of the side walls and is arranged to be opposed to the circuit board (2); and an external connection terminal (4) fixed to the flat plate portion (314), in which the shield case (31) includes a first area, in which the flat plate portion (314) is arranged, and a second area surrounding a portion of the circuit board (2) mounted with the electronic component (21). The flat plate portion (314) includes an external connection terminal fixing portion (315) including at least three projections (317) that are held in contact with the external connection terminal (4).

This application is based on Japanese Patent Application No. 2009-163417 filed on Jul. 10, 2009, the contents of which are hereby incorporated by reference.

### BACKGROUND OF THE INVENTION

1. Field of the Invention

The present invention relates to a tuner unit that can be mounted on a flat-screen television receiver using a liquid crystal display panel (LCDP), a plasma display panel (PDP), or the like, and to a flat-screen television receiver using the tuner unit.

2. Description of Related Art

In recent years, there has been widely spread a flat-screen television receiver using a liquid crystal display panel (LCDP) or a plasma display panel (PDP), which is advantageous in terms of power saving, panel-size increase, and space saving. The flat-screen television receiver itself is thin, and hence a tuner to be built therein is also required to reduce its thickness.

A conventional tuner built in the flat-screen television receiver is described with reference to the drawings. FIG. 15 is a perspective view of the conventional tuner. As illustrated in FIG. 15, a tuner 91 includes a circuit board 92 on which electronic components 921 are mounted, a shield case 93 arranged so as to surround the circuit board 92, and an antenna input terminal 94, which protrudes from a side surface of the shield case 93, and to which an antenna cable is connected. Further, the shield case 93 includes a partition portion 932 partitioning a region of the circuit board 92 surrounded by the shield case 93, and leg portions 933 protruding from a lower portion of the shield case 93. Further, a metal cover (not shown) is attached onto an upper portion of the shield case 93. The tuner 91 is fixed as follows. Specifically, the leg portions 933 are inserted through through-holes (not shown) formed in a main board of the flat-screen television receiver, and the leg portions 933 are soldered to wiring of the main board (see Japanese Patent Application Laid-open No. Hei 10-284866 and Japanese Patent Application Laid-open No. 2002-190684).

A conventional flat-screen television receiver using the tuner is described with reference to the drawings. FIG. 16 is a sectional view of the conventional flat-screen television receiver. A flat-screen television receiver B illustrated in FIG. 16 includes a front cabinet Fc and a rear cabinet Rc that cover a liquid crystal display unit LU using the liquid crystal display panel. A main board MB (external board) is fixed on a rear side of the liquid crystal display unit LU, and the tuner 91 is mounted to the main board MB. When the tuner 91 is mounted to the main board MB, the antenna input terminal 94 extends along the main board MB. The flat-screen television receiver B has a structure in which the antenna input terminal 94 is exposed to the outside from the rear cabinet Rc. Accordingly, a rear shape of the rear cabinet Rc is complicated (for example, as illustrated in FIG. 16). Therefore, it takes a lot of labor and time to manufacture the rear cabinet Rc and assembly the flat-screen television receiver B. Further, in the flat-screen television receiver B, the antenna input terminal 94 protrudes along a rear surface of the rear cabinet Rc, and hence it is troublesome to connect an antenna line to the antenna input terminal 94.

In this context, in order to simplify the shape of the rear cabinet Rc, an improved tuner is proposed. The improved tuner is described with reference to the drawings. FIG. 17 is a perspective view of the improved tuner. A tuner 95 illustrated in FIG. 17 has the same configuration as that of the tuner unit 91 illustrated in FIG. 15 except that the antenna input terminal 94 is fixed at a different position. Substantially the same portions of the tuner unit 95 as those of the tuner unit 91 are denoted by the same symbols, and detailed description of substantially the same portions of the tuner unit 95 as those of the tuner unit 91 is omitted. The tuner 95 illustrated in FIG. 17 includes a flat plate portion 934 provided to an opening of the upper portion of the shield case 93 to be parallel to the circuit board 92. Further, the antenna input terminal 94 extending in a direction orthogonal to the flat plate portion 934 is arranged (see Japanese Patent Application Laid-open No. 2004-134842).

When the tuner 95 is mounted to the main board MB, the antenna input terminal 94 protrudes in a thickness direction of the television receiver. With this configuration, even when the (rear) shape of the rear cabinet Rc of the flat-screen television receiver is simplified (formed into a flat shape), it is possible to expose the antenna input terminal 94 to the outside of the rear cabinet Rc. Further, it is easy to connect the antenna line to the antenna input terminal.

In recent years, it has been promoted to unitize the tuner, i.e., to incorporate a function integrated circuit (IC) of a television set into the tuner to thereby obtain a tuner unit. Along with unitization of the tuner, a large number of heat generating bodies (electronic components: ICs) are mounted to the tuner unit. Further, the IC has been sophisticated (highly integrated), and hence a heat of the IC itself becomes larger than that of the conventionally-mounted IC.

Further, as illustrated in FIG. 17, in the tuner 95, the antenna input terminal 94 is provided onto the flat plate portion 934. A distance between the flat plate portion 934 and each of the electronic components 921 (ICs 921) serving as the heat generating bodies is shorter than that in a case of the conventional tuner 91. With this configuration, in comparison with the conventional tuner, the heat generated from the ICs 921 is more likely to be transferred to the flat plate portion 934. Further, as illustrated in FIG. 17, as a contact area between the flat plate portion 934 and the antenna input terminal 94 becomes larger, the amount of heat conducted from the flat plate portion 934 to the antenna input terminal 94 becomes larger. According to the above description, in the tuner 95 illustrated in FIG. 17, in comparison with the tuner 91 illustrated in FIG. 15, the antenna input terminal 94 is more likely to reach high temperature.

In the flat-screen television receiver including the tuner 95, a tip of the antenna input terminal 94 protrudes from the rear surface of the rear cabinet, and hence part of the body of a worker or a user tends to touch the tip of the antenna input terminal 94. During operation of the tuner 95, the tip of the antenna input terminal 94 protruding from the rear surface of the rear cabinet Rc also reaches high temperature. When part of the body of a worker or a user touches the tip of the antenna input terminal, the worker or the user feels discomfort and pain at the part of the body touching the antenna input terminal.

In this context, in order to inhibit the heat from being conducted to the antenna input terminal, a tuner described in Japanese Patent Application Laid-open No. 2002-190684 includes the following heat radiator. In the heat radiator, a metal heat transfer plate portion is brought into contact with an IC of a digital circuit, and heat is radiated to the outside from a heat-radiating surface of the heat transfer plate portion. However, the heat radiator is configured to transfer the heat of the IC to the outside (into the air). Thermal resistance from the heat-radiating surface to the air is extremely high, and hence it is difficult to obtain sufficient heat-radiating effect. In other words, with this configuration, it is sometimes impossible to suppress temperature rise of the antenna input terminal.

### SUMMARY OF THE INVENTION

The present invention has been made in view of the above-mentioned circumstances, and therefore it is an object of the present invention to provide a tuner unit that suppresses the antenna input terminal from reaching high temperature and is less likely to give pain and discomfort to a worker or a user due to heat even when the worker or the user touches a portion of the antenna input terminal exposed to the outside, and to provide a flat-screen television receiver including the tuner unit.

According to one aspect of the present invention, a tuner unit includes: a circuit board on which an electronic component is mounted; a shield case including a plurality of side walls surrounding the circuit board, and a flat plate portion that is integrated with at least one of the plurality of side walls and is arranged to be opposed to the circuit board; and an external connection terminal fixed to the flat plate portion. Further, the shield case includes a first area, in which the flat plate portion is arranged, and a second area surrounding a portion of the circuit board mounted with the electronic component.

According to the above-mentioned configuration, the flat plate portion is arranged at a position (first area) away from the electronic component having a large heat generation amount. Further, the external connection terminal is fixed to the flat plate portion, and hence heat generated from the electronic component is conducted for a long distance until the heat reaches the external connection terminal.

Thus, thermal resistance from the electronic component to the external connection terminal is high, and hence the amount of heat conducted to the external connection terminal is reduced. As a result, temperature rise of the external connection terminal is suppressed. In addition, even when part of the body of a worker or a user touches a tip of the external connection terminal, the worker or the user is less likely to feel pain and discomfort due to the heat at the part of the body touching the external connection terminal.

According to a preferred aspect of the present invention, the flat plate portion includes an external connection terminal fixing portion including at least three projections that are held in contact with the external connection terminal.

According to the above-mentioned configuration, the external connection terminal is held in contact with the flat plate portion through the projections, and a contact area between the external connection terminal and the flat plate portion is small. The contact area between the external connection terminal and each of the projections is small, and hence thermal resistance between the external connection terminal fixing portion and the external connection terminal is high so that the heat is less likely to be conducted therebetween. Thus, the temperature of the external connection terminal is less likely to rise. Even when part of the body of a worker or a user touches the tip of the external connection terminal, the worker or the user is less likely to feel pain and discomfort due to the heat at the part of the body touching the external connection terminal.

According to a preferred aspect of the present invention, the shield case includes a plurality of leg portions that are formed on the plurality of side walls to be connected to an external board, and has a structure in which more leg portions are situated in the second area than in the first area.

According to the above-mentioned configuration, the heat of the electronic component in the second area is conducted from the leg portions of the side walls to the external board, and hence it is possible to reduce the amount of heat conducted to the flat plate portion. Therefore, the amount of heat conducted to the external connection terminal fixed to the flat plate portion is reduced, and thus temperature rise of the external connection terminal is suppressed. With this, even when part of the body of a worker or a user touches the tip of the external connection terminal, the worker or the user is less likely to feel pain and discomfort due to the heat at the part of the body touching the external connection terminal.

According to a preferred aspect of the present invention, the shield case includes a through window formed in at least one of the plurality of side walls over the first area and the second area.

According to the above-mentioned configuration, the through window is formed in at least one of the side walls, and hence areas of the side walls subjected to heat conduction are decreased. With this, thermal resistance of the side walls is increased, and thus the amount of heat conducted from the second area to the first area is decreased. As a result, the amount of heat conducted from the electronic component to the flat plate portion is reduced, and temperature rise of the external connection terminal is suppressed. With this, even when part of the body of a worker or a user touches the tip of the external connection terminal, the worker or the user is less likely to feel pain and discomfort due to the heat at the part of the body touching the external connection terminal.

Further, the through window may have, for example, a shape with one large through-hole or a shape with a plurality of aligned through-holes (for example, lattice shape with rectangular holes in a two dimensional array). In a case of the through window with a plurality of aligned holes, it is possible to reduce a size of each of the holes, and hence possible to suppress strength reduction of the side walls while increasing the thermal resistance.

Further, there may be adopted a configuration in which at least one leg portion is formed in a vicinity of an end on a side of the second area of the through window formed in at least one of the side walls. The at least one leg portion is formed in the vicinity of the through window in this way, and hence it is possible to ensure strength of the side walls. Further, the at least one leg portion is arranged, and hence heat in the second area of the side walls is transferred from the at least one leg portion to the external board so that the amount of heat transferred to the flat plate portion is reduced. The amount of heat conducted to the external connection terminal fixed to the flat plate portion is reduced, and thus temperature rise of the external connection terminal is suppressed. As a result, even when part of the body of a worker or a user touches the tip of the external connection terminal, the worker or the user is less likely to feel pain and discomfort due to the heat at the part of the body touching the external connection terminal.

According to a preferred aspect of the present invention, a shield case further includes a partition member that is coupled to at least one of the plurality of side walls of the shield case and is arranged in a vicinity of the electronic component. The partition member includes: a partition portion for partitioning off a part, which contains the electronic component, of a portion of the circuit board surrounded by the plurality of side walls; a heat transfer plate continuous with the partition portion, for covering a surface of the electronic component while being held in contact with the surface of the electronic component; a support portion continuous with an opposite side of a portion of the heat transfer plate continuous with the partition portion, for supporting the heat transfer plate; and leg pieces that protrude on an end portion of the partition portion and an end of the support portion, respectively, protrude from a surface of the circuit board opposite to a surface of the circuit board mounted with the electronic component, and are soldered to an external board.

According to the above-mentioned configuration, the heat transfer plate is held in direct contact with the electronic component, and hence the heat of the electronic component is transferred directly to the heat transfer plate. Further, the heat conducted to the heat transfer plate is conducted to the external board through the leg pieces formed on the partition portion and the support portion. With this, the heat conducted to the flat plate portion arranged away from the electronic component is reduced. Thus, the heat conducted to the external connection terminal fixed to the flat plate portion is reduced, and thus temperature rise of the external connection terminal is suppressed. As a result, even when part of the body of a worker or a user touches the tip of the external connection terminal, the worker or the user is less likely to feel pain and discomfort due to the heat at the part of the body touching the external connection terminal.

According to a preferred aspect of the present invention, a shield case further includes a partition member that is coupled to at least one of the plurality of side walls of the shield case and is arranged in a vicinity of the electronic component. The partition member includes: a partition portion for partitioning off a part, which contains the electronic component, of a portion of the circuit board surrounded by the plurality of side walls; a heat transfer plate that is continuous with the partition portion, and is held in contact with a back side of the portion of the circuit board mounted with the electronic component; a support portion continuous with an opposite side of a portion of the heat transfer plate continuous with the partition portion, for supporting the heat transfer plate; and leg pieces that protrude on an end portion of the partition portion and an end of the support portion, respectively, protrude from a surface of the circuit board opposite to a surface of the circuit board mounted with the electronic component, and are soldered to an external board.

According to the above-mentioned configuration, the heat transfer plate is held in contact with the back side of the portion of the circuit board mounted with the electronic component. The heat of the electronic component is transferred to the heat transfer plate through the circuit board. Further, the heat conducted to the heat transfer plate is conducted to the external board through the leg pieces formed on the partition portion and the support portion. With this, it is possible to reduce the heat conducted to the flat plate portion arranged away from the electronic component. Thus, the heat conducted to the external connection terminal fixed to the flat plate portion is reduced, and thus temperature rise of the external connection terminal is suppressed. As a result, even when part of the body of a worker or a user touches the tip of the external connection terminal, the worker or the user is less likely to feel pain and discomfort due to the heat at the part of the body touching the external connection terminal.

According to a preferred aspect of the present invention, a shield case further includes a partition member that is coupled to at least one of the plurality of side walls of the shield case and is arranged in a vicinity of the electronic component. The partition member includes: a pair of partition portions for partitioning off a part, which contains the electronic component, of a portion of the circuit board surrounded by the plurality of side walls; a heat transfer plate continuous with the pair of partition portions, for covering a surface of the electronic component while being held in contact with the surface of the electronic component; and leg pieces that protrude on ends of the pair of partition portions, respectively, protrude from a surface of the circuit board opposite to a surface of the circuit board mounted with the electronic component, and are soldered to an external board.

According to the above-mentioned configuration, the heat transfer plate is coupled between the pair of partition portions, and hence it is possible to partition the region surrounded by the side walls even if another partition member other than the partition member is not provided. Further, a metal plate is cut and bent (with less steps) to thereby enable two partition portions to be provided, and hence it is possible to reduce labor and time necessary for manufacture. In addition, the leg pieces are opposed to each other when the leg pieces are formed by cutting and bending the metal plate, and hence a residual portion of the metal plate remaining after working is reduced. As a result, it is possible to achieve waste reduction.

According to a preferred aspect of the present invention, a shield case further includes a partition member that is coupled to at least one of the plurality of side walls of the shield case and is arranged in a vicinity of the electronic component. Further, the partition member includes: a pair of partition portions for partitioning off a part, which contains the electronic component, of a portion of the circuit board surrounded by the plurality of side walls; a heat transfer plate that is continuous with the pair of partition portions, and is held in contact with a back surface of the portion of the circuit board mounted with the electronic component; and leg pieces that protrude on ends of the pair of partition portions, respectively, protrude from a surface of the circuit board opposite to a surface of the circuit board mounted with the electronic component, and are soldered to an external board.

According to the above-mentioned configuration, the heat transfer plate is coupled between the pair of partition portions, and hence it is possible to partition the region surrounded by the side walls even if another partition member other than the partition member is not provided. Further, a metal plate is cut and bent (with less steps) to thereby enable two partition portions to be provided, and hence it is possible to reduce labor and time necessary for manufacture. In addition, the leg pieces are opposed to each other when the leg pieces are formed by cutting and bending the metal plate, and hence a residual portion of the metal plate remaining after working is reduced. As a result, it is possible to achieve waste reduction.

According to a preferred aspect of the present invention, at least one of the leg pieces is soldered to the circuit board.

According to a preferred aspect of the present invention, a shield case further includes a shield cover for covering both sides of a region surrounded by the plurality of side walls of the shield case. The shield cover includes, on a side opposed to an external board, a contact portion formed by cutting and bending a middle portion of the shield cover. The contact portion includes: a heat transfer portion held in contact with a surface of the electronic component; a coupling portion for coupling the heat transfer portion and the shield cover together; and a connection portion that is arranged in a vicinity of the coupling portion and is connected to the external board.

According to a preferred aspect of the present invention, a shield case further includes a shield cover for covering both sides of a region surrounded by the plurality of side walls of the shield case. The shield cover includes, on a side opposed to an external board, a contact portion formed by cutting and bending a middle portion of the shield cover. The contact portion includes: a heat transfer portion held in contact with a back surface of the portion of the circuit board mounted with the electronic component; a coupling portion for coupling the beat transfer portion and the shield cover together; and a connection portion that is arranged in a vicinity of the coupling portion and is connected to the external board.

According to a preferred aspect of the present invention, the shield case includes, in a vicinity of the portion of the circuit board mounted with the electronic component, a flat portion integrated with at least one of the plurality of side walls. The flat portion is spaced apart from the flat plate portion, and includes a tapped screw hole. By fastening the shield case through the tapped screw hole to the heat transfer portion provided to an external case or the like, it is possible to conduct the heat of the shield case to the heat transfer portion.

As a device including the above-mentioned tuner unit, there may be exemplified a flat-screen television receiver using a flat panel such as a LCDP or a PDP.

### BRIEF DESCRIPTION OF THE DRAWINGS

In the accompanying drawings:

FIG. 1 is a schematic sectional view of a flat-screen television receiver on which a tuner unit according to the present invention is mounted;

FIG. 2 is a perspective view of the tuner unit according to the present invention;

FIG. 3 is an enlarged sectional view of a portion of the tuner unit illustrated in FIG. 2, to which an antenna input terminal is fixed;

FIG. 4 is a perspective view of a tuner unit according to another embodiment of the present invention;

FIG. 5 is a perspective view of a tuner unit according to still another embodiment of the present invention;

FIG. 6 is a side view of a tuner unit according to still another embodiment of the present invention;

FIG. 7A is a plan view of a tuner unit according to still another embodiment of the present invention;

FIG. 7B is a sectional front view of the tuner unit according to the still another embodiment of the present invention;

FIG. 7C is a sectional side view of the tuner unit according to the still another embodiment of the present invention;

FIG. 8A is a plan view of a tuner unit according to still another embodiment of the present invention;

FIG. 8B is a sectional front view of the tuner unit according to the still another embodiment of the present invention;

FIG. 8C is a sectional side view of the tuner unit according to the still another embodiment of the present invention;

FIG. 9 is an enlarged view of a periphery of a partition member of a tuner unit according to still another embodiment of the present invention;

FIG. 10 is a view of a metal plate with cutting lines and bending lines before the partition member is manufactured;

FIG. 11 is an enlarged view of a periphery of the partition member of the tuner unit according to the still another embodiment of the present invention;

FIG. 12 is a view of a metal plate with cutting lines and bending lines before a shield section is manufactured;

FIG. 13 is a sectional view of a tuner unit according to still another embodiment of the present invention;

FIG. 14 is a plan view of a tuner unit according to still another embodiment of the present invention;

FIG. 15 is a perspective view of a conventional tuner;

FIG. 16 is a sectional view of a flat-screen television receiver provided with the tuner illustrated in FIG. 15; and

FIG. 17 is a perspective view illustrating an example of an improved tuner.

### DETAILED DESCRIPTION OF PREFERRED EMBODIMENTS

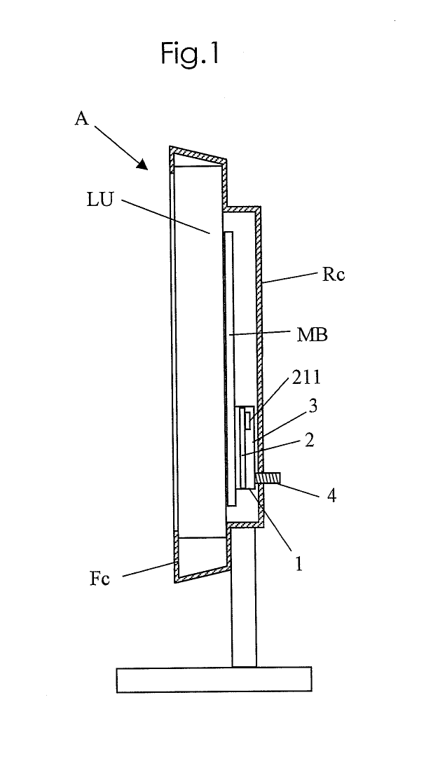

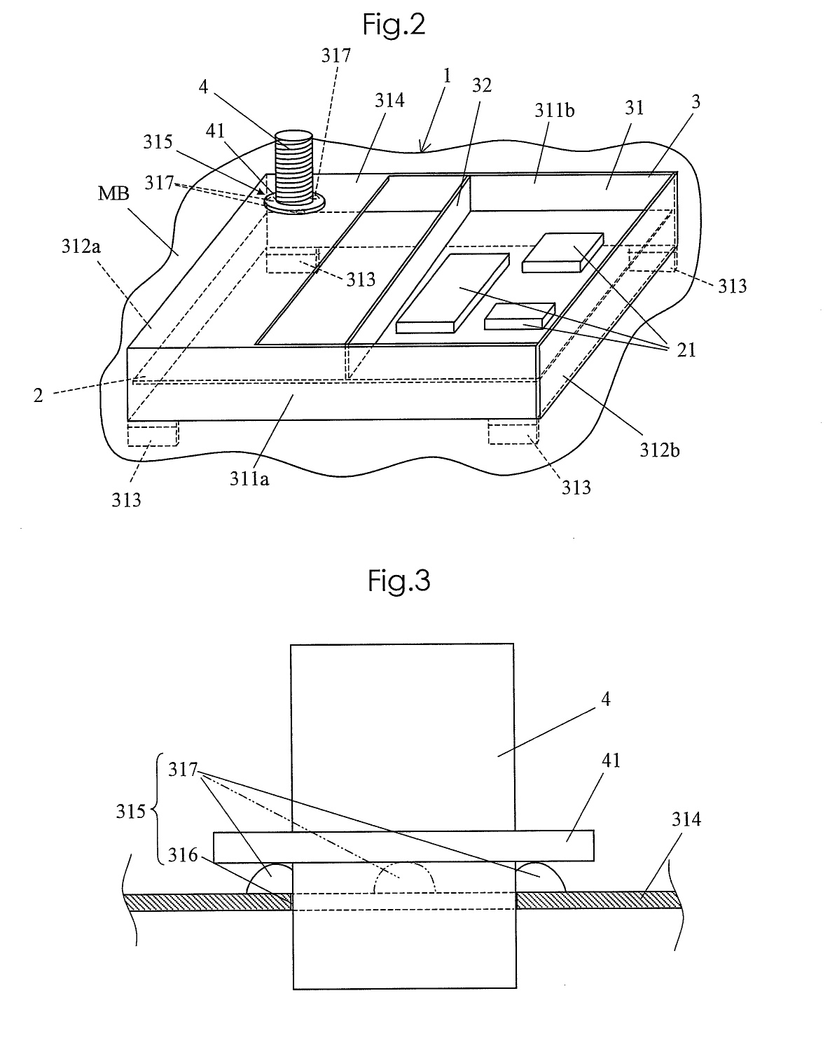

In the following, embodiments of the present invention are described with reference to the drawings. FIG. 1 is a schematic sectional view of a flat-screen television receiver on which a tuner unit according to the present invention is mounted, and FIG. 2 is a perspective view of the tuner unit according to the present invention. A flat-screen television receiver A illustrated in FIG. 1 is a liquid crystal television receiver using a liquid crystal display panel. In the flat-screen television receiver A, a liquid crystal display unit LU including the liquid crystal display panel is arranged to be covered with a front cabinet Fc and a rear cabinet Rc. A main board MB (external board) is fixed on a rear side of the liquid crystal display unit LU. Further, a tuner unit 1 is mounted on the main board MB. A tip of an antenna input terminal 4 of the tuner unit 1, to be described below, protrudes from the rear cabinet Rc to the rear side.

The tuner unit 1 illustrated in FIG. 2 is a tuner unit including electronic components (integrated circuits (ICs)) installed in the flat-screen television receiver, for receiving television broadcasting (terrestrial digital broadcasting, or satellite digital broadcasting). The tuner unit 1 includes a circuit board 2, a shield section 3 arranged to surround the circuit board 2, and the antenna input terminal 4 which is provided to the shield section 3 and to which an antenna cable is connected.

The circuit board 2 is a plate-like printed circuit board having a rectangular shape in plan view, and includes, on a surface thereof, a wiring pattern formed of a thin metal film (copper, aluminum, or the like). On the circuit board 2, there is formed an electric circuit constituted by a plurality of electronic components connected to the wiring pattern. Electronic components (ICs) 21 having a large heat are included in the plurality of electronic components constituting the electric circuit.

The shield section 3 is formed by bending a metal plate, such as a terne sheet or a tin plate, into a small piece by press working or the like, and is arranged so as to cover the circuit board 2. The shield section 3 includes a shield case 31 surrounding side portions of the circuit board 2.

The shield case 31 has a rectangular shape in plan view, and includes a pair of longitudinal side walls 311a, 311b and a pair of lateral side walls 312a, 312b. The pair of longitudinal side walls 311a, 311b are arranged to be opposed to each other, and the pair of lateral side walls 312a, 312b are also arranged to be opposed to each other. Further, the longitudinal side walls 311a, 311b are orthogonal to the lateral side walls 312a, 312b. The longitudinal side wall 311a, the lateral side wall 312a, the longitudinal side wall 311b, and lateral side wall 312b are coupled in the stated order, and surround side surfaces of the circuit board 2 having a rectangular parallelepiped shape. Further, the longitudinal side walls 311a, 311b and the lateral side walls 312a, 312b are orthogonal to the circuit board 2.

At both ends in a longitudinal direction of the longitudinal side wall 311a, 311b, there are respectively provided protruding portions (not shown) further protruding in the longitudinal direction. Further, in vicinities of both ends in the longitudinal direction of the lateral side wall 312a, 312b, there are respectively provided openings (not shown) corresponding to the protruding portions of the longitudinal side wall 311a, 311b. The protruding portions of the longitudinal side wall 311a, 311b are fitted into the opening of the lateral side wall 312a and the opening of the lateral side wall 312b, and portions of the protruding portions protruding from the openings are caulked. As a result, adjacent side walls are fixed and coupled to each other.

Further, at the both ends in the longitudinal direction of the longitudinal side wall 311a, 311b, there are respectively formed leg portions 313 protruding downward. The leg portions 313 are inserted into openings of the main board MB and are subjected to soldering or the like. In this way, the shield case 31 and the wiring pattern of the main board MB are electrically connected together, and the tuner unit 1 is fixed onto the main board MB. Note that, the leg portions 313 are connected to ground wiring of the main board MB, and an entire of the shield section 3 is grounded thereto.

Note that, in the tuner unit 1 illustrated in FIG. 2, the leg portions 313 of the shield case 31 are formed on the longitudinal side walls 311a, 311b. However, the leg portions 313 may be formed on the lateral side walls 312a, 312b, or may be formed on both the longitudinal side walls and the lateral side walls.

Further, the shield case 31 includes a flat plate portion 314 fixing at least one external connection terminal. Note that, the tuner unit 1 in this embodiment includes one antenna input terminal 4 serving as the external connection terminal.

The flat plate portion 314 is arranged to be opposed to the circuit board 2. The flat plate portion 314 is integrated with, among the plurality of side walls surrounding the circuit board 2, the longitudinal side walls 311a, 311b and the lateral side wall 312a that couples those two longitudinal side walls together.

The shield case 31, in which the flat plate portion 314, the longitudinal side walls 311a, 311b, and the lateral side wall 312a are integrated together, is formed by bending one metal plate into a box shape while performing press working on sides of the metal plate with reference to the flat plate portion 314. By performing press working on the metal plate, it is possible to obtain the flat plate portion 314 integrated with upper sides of the longitudinal side walls 311a, 311b and an upper portion of the lateral side wall 312a. Details of the flat plate portion 314 are described below.

The shield case 31 includes a partition member 32 for partitioning the region of the circuit board 2 surrounded by the longitudinal side walls 311a, 311b and the lateral side walls 312a, 312b. The partition member 32 is a rectangular plate member formed of the same metal plate forming the above-mentioned side walls, and is arranged to be perpendicular to the circuit board 2. Note that, the shield section 3 illustrated in FIG. 2 includes one partition member 32. However, the shield section 3 is not limited thereto, and may include a plurality of partition members according to the number of regions obtained by partitioning. Further, the partition member 32 may be bent according to a shape of a region obtained by partitioning.

The partition member 32 is arranged so as to be orthogonal to the circuit board 2 and the longitudinal side walls 311a, 311b. Similarly to the longitudinal side walls 311a, 311b, the partition member 32 includes, at both ends in the longitudinal direction thereof, protruding portions (not shown) further protruding in the longitudinal direction. The protruding portions are fitted into openings (not shown) provided at corresponding positions of the longitudinal side walls 311a, 311b, and are fixed by caulking. In this way, the partition member 32 is connected and fixed to the longitudinal side walls 311a, 311b. Due to being fixed with the partition member 32, the shield case 31 is reinforced. Note that, the openings in which the protruding portions of the partition member 32 are caulked may be provided to the lateral side walls 312a, 312b or another partition member 32. Further, leg portions (not shown) may be formed in a lower portion of the partition member 32, and the leg portions may pass through the circuit board 2 and the main board MB and may be soldered onto the wiring pattern of each of the circuit board 2 and the main board MB. In this case, the partition member 32 is fixed to the main board MB by soldering of the leg portions.

The partition member 32 acts for reinforcing the shield case 31, and also acts as a partition for ensuring isolation of electric circuits (electronic components) that are formed in different regions of regions partitioned by the partition member 32.

Next, the antenna input terminal fixed onto the flat plate portion is described in detail with reference to the drawings. FIG. 3 is an enlarged sectional view of a portion of the tuner unit illustrated in FIG. 2, to which the antenna input terminal is fixed.

As illustrated in FIG. 3, in the flat plate portion 314, there is formed an antenna input terminal fixing portion 315 (external connection terminal fixing portion) including an antenna input terminal fixing hole 316 formed therein. The antenna input terminal fixing portion 315 also includes three projections 317 around the antenna input terminal fixing hole 316. The projections 317 are spherical protrusions formed by pushing the flat plate portion 314 from the circuit board 2 side so as to protrude therefrom. The three projections 317 are arranged to surround the antenna input terminal fixing hole 316. The three projections 317 have an equal height from the surface of the flat plate portion 314 to tips of the projections. Note that, the adjacent projections 317 are spaced circumferentially at equal intervals around the antenna input terminal fixing hole 316.

Note that, though the antenna input terminal fixing portion 315 of the shield case 31 includes the three projections 317, the antenna input terminal fixing portion 315 is not limited thereto. The projections 317 abut against a pedestal portion 41 having a flat shape to be described below, and hence it is preferred that the antenna input terminal fixing portion 315 include at least three projections.

The antenna input terminal 4 is connected to an external antenna cable (not shown), and has a cylindrical shape. The antenna input terminal 4 includes the flange-like pedestal portion 41 in a middle portion in an axial direction thereof. Note that, the pedestal portion 41 is orthogonal to a center axis of the antenna input terminal 4. One end of the antenna input terminal 4 with respect to the pedestal portion 41 passes through the antenna input terminal fixing hole 316 to protrude to the circuit board 2 side. By caulking the end of the antenna input terminal 4 protruding from the antenna input terminal fixing hole 316, the pedestal portion 41 is pressed against the projections 317, and thus the antenna input terminal 4 is fixed. Note that, the end of the antenna input terminal 4 protruding from the antenna input terminal fixing hole 316 has an insulating property, and is made of a material with low thermal conductivity.

The flange-like pedestal portion 41 is held in contact with the tips of the three projections 317. The pedestal portion 41 is held in contact with the projections 317 so that the antenna input terminal 4 is grounded. The projections 317 have the equal height from the flat plate portion 314, and hence a surface of the pedestal portion 41 held in contact with the projections 317 is parallel to the flat plate portion 314. Further, the center axis of the antenna input terminal 4 is orthogonal to the flat plate portion 314. That is, the antenna input terminal 4 is fixed while protruding perpendicularly to the flat plate portion 314.

Next, heat of the tuner unit 1 is described. When the electric circuit is energized, the tuner unit 1 generates heat due to resistance of the electric circuit. In particular, the ICs 21 driving at high frequency have a large heat. Further, the heat of the ICs 21 is transferred to the shield case 31 arranged in the vicinities of the ICs 21.

The heat transferred to the shield case 31 is conducted to the longitudinal side walls 311a, 311b, and is conducted to the wiring connected to the leg portions 313 of the main board MB. Meanwhile, the heat is conducted also to the flat plate portion 314 through the longitudinal side walls 311a, 311b. The heat conducted to the flat plate portion 314 is conducted to the antenna input terminal 4 through the antenna input terminal fixing portion 315.

As described above, a contact area between the pedestal portion 41 of the antenna input terminal 4 and the projections 317 is extremely small, and thus thermal resistance between the projections 317 and the pedestal portion 41 is high (thermal conductivity is low). With this configuration, the heat is less likely to be conducted from the flat plate portion 314 to the pedestal portion 41, and temperature rise of the antenna input terminal 4 is suppressed. Thus, the tip of the antenna input terminal 4 protruding from the rear cabinet Rc to the outside is less likely to reach high temperature. Owing to this, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

As illustrated in FIG. 3, the projections 317 have dome shape. However, the projections 317 are not limited thereto, and may have a conical shape or a pyramidal shape such as a triangular pyramid or a quadrangular pyramid. As the projections, there may be widely adopted projections having a shape capable of supporting the pedestal portion 41 of the antenna input terminal 4 parallelly to the flat plate portion 314 of the shield case 31. Further, a ridge shape extending radially about the antenna input terminal attachment hole 316 and a continuous or discontinuous ridge shape extending circumferentially to surround the antenna input terminal attachment hole 316 may be exemplified.

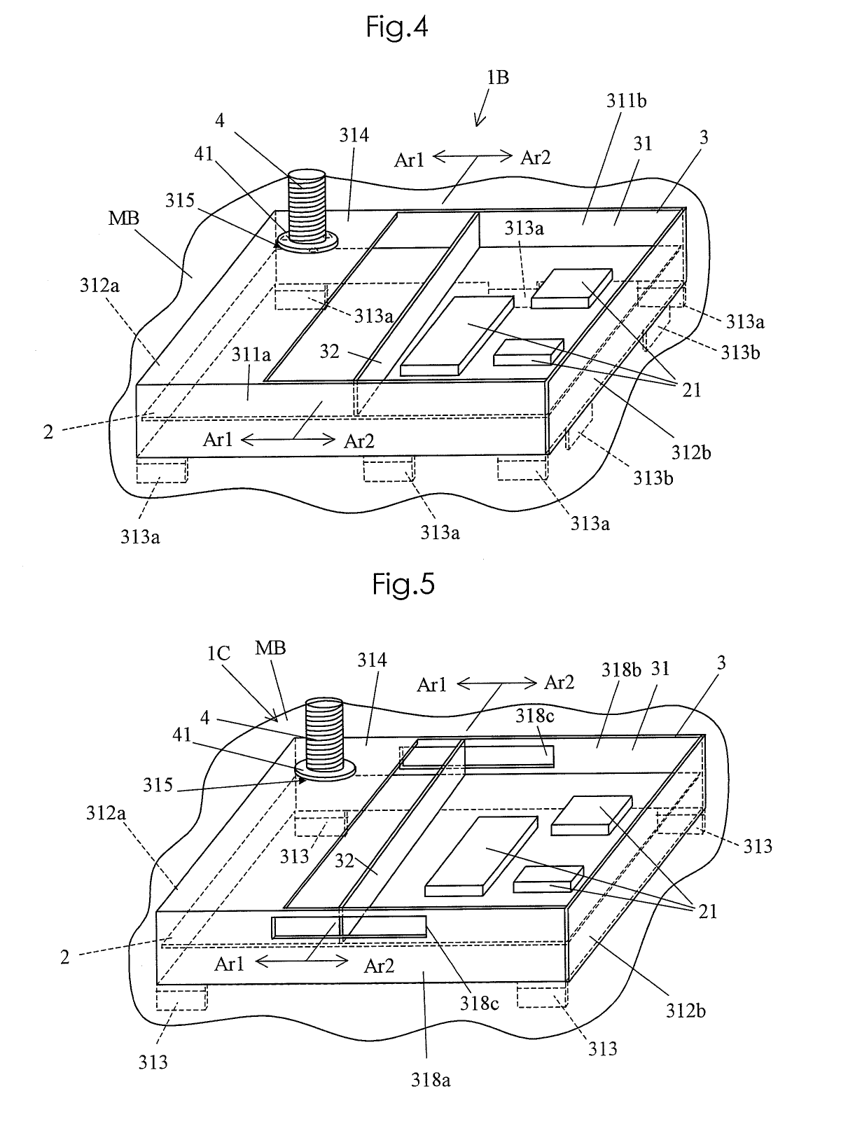

A tuner unit according to another embodiment of the present invention is described with reference to the drawings. FIG. 4 is a perspective view of the tuner unit according to another embodiment of the present invention. A tuner unit 1B illustrated in FIG. 4 has the same configuration as that of the tuner unit 1 illustrated in FIG. 2 except for including leg portions 313a, 313b different from the above-mentioned leg portions. Note that, substantially the same portions of the tuner unit 1B as those of the tuner unit 1 are denoted by the same symbols. Further, detailed description of substantially the same portions of the tuner unit 1B as those of the tuner unit 1 is omitted.

For convenience of description, the tuner unit 1B is divided into a first area Ar1 including the flat plate portion 314 and a residual second area Ar2 (see FIG. 4). In the tuner unit 1B illustrated in FIG. 4, the electric circuit including the ICs 21 having the large heat generation amount is situated in the second area Ar2. As illustrated in FIG. 4, two leg portions 313a are formed on portions in the second area Ar2 of each of the longitudinal side walls 311a, 311b of the shield case 31. Further, the leg portions 313b are respectively formed also on the both ends in the longitudinal direction of the lateral side wall 312b arranged in the second area Ar2.

When the tuner unit 1B is driven, the ICs 21 included in the electric circuit generate heat. The heat of the ICs 21 is transferred to the lateral side wall 312b and the portions in the second area of the longitudinal side walls 311a, 311b of the shield case 31. The heat transferred to the longitudinal side walls 311a, 311b is conducted to the main board MB through the leg portions 313a. Further, the heat transferred to the lateral side wall 312b is similarly conducted to the main board MB through the leg portions 313b.

The heat of the ICs 21 is conducted in a distributed manner to the main board MB through the leg portions 313a, 313b, and hence it is possible to reduce an amount of heat conducted to portions in the first area Ar1 of the longitudinal side walls 311a, 311b. Further, it is possible to suppress heat conduction to the flat plate portion 314, and to reduce the heat conducted to the antenna input terminal 4. Thus, the tip of the antenna input terminal 4 protruding from the rear cabinet Rc to the outside is less likely to reach high temperature. When part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

A tuner unit according to still another embodiment of the present invention is described with reference to the drawings. FIG. 5 is a perspective view of the tuner unit according to the still another embodiment of the present invention. A tuner unit 1C illustrated in FIG. 5 has the same configuration as that of the tuner unit 1 illustrated in FIGS. 1 and 2 except for including longitudinal side walls 318a, 318b different from the above-mentioned longitudinal side walls. Substantially the same portions of the tuner unit 1C as those of the tuner unit 1 are denoted by the same symbols. Further, detailed description of substantially the same portions of the tuner unit 1C as those of the tuner unit 1 is omitted.

As illustrated in FIG. 5, each of the longitudinal side walls 318a, 318b of the tuner unit 1C includes a through window 318c in a vicinity of a boundary between the first area Ar1 and the second area Ar2. A portion of each of the longitudinal side walls 318a, 318b provided with the through window 318c has a small sectional area and high thermal resistance. With this configuration, the heat transferred from the ICs 21 is less likely to be conducted from the longitudinal side walls 318a, 318b on the second area Ar2 side to those on the first area Ar1 side. It is possible to suppress the heat conducted to the flat plate portion 314 in the first area Ar1, and to reduce the heat conducted to the antenna input terminal 4. Thus, the tip of the antenna input terminal 4 exposed from the rear cabinet Rc to the outside is less likely to reach high temperature. Owing to this, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

In the tuner unit 1C, the through window 318c is a rectangular through-hole. However, the through window 318c is not limited thereto, and may have an elliptic shape or a polygonal shape other than the rectangular shape. Further, a plurality of small openings may be aligned in a predetermined order, to thereby form a window. In a case of this shape, it is possible to make each of the openings small, and hence it is possible to suppress reduction in strength of the longitudinal side walls 318a, 318b.

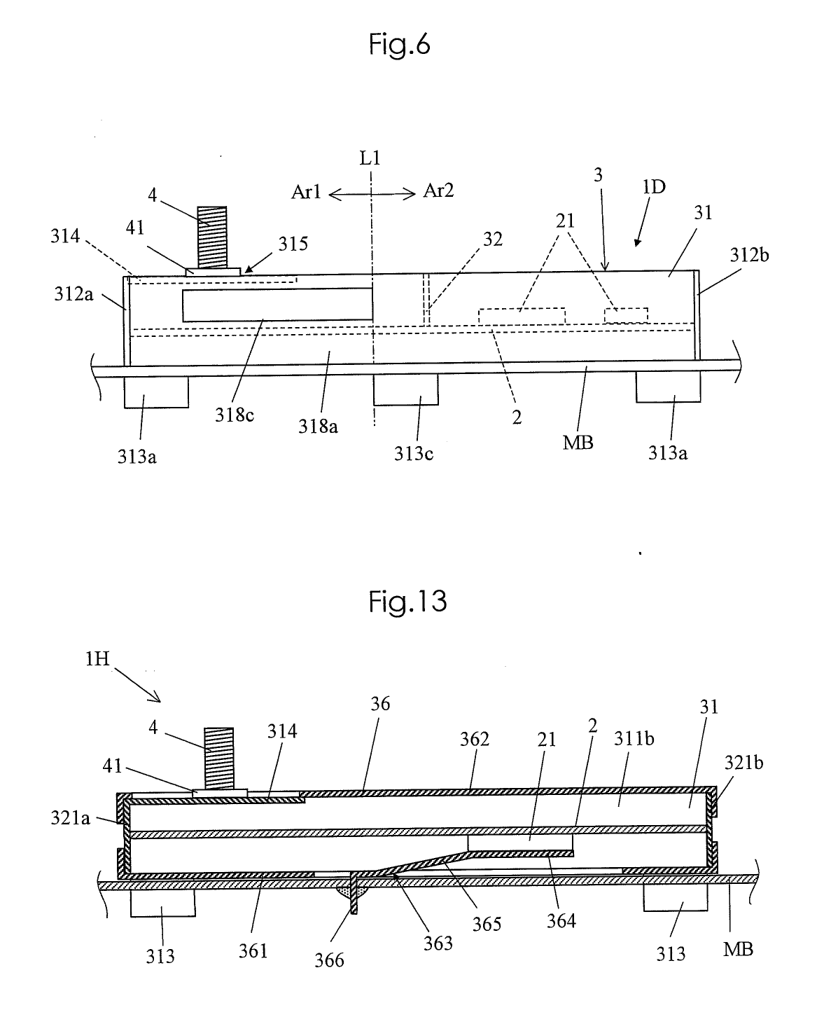

A tuner unit according to still another embodiment of the present invention is described with reference to the drawings. FIG. 6 is a side view of the tuner unit according to the still another embodiment of the present invention. A tuner unit 1D illustrated in FIG. 6 includes the through windows 318c in the portions in the first area Ar1 of the longitudinal side walls 318a, 318b. The tuner unit 1D has the same configuration as that of the tuner unit 1B illustrated in FIG. 4 except for the through windows 318c, and substantially the same portions of the tuner unit 1D as those of the tuner unit 1B are denoted by the same symbols. Note that, detailed description of substantially the same portions of the tuner unit 1D as those of the tuner unit 1B is omitted. Note that, though, for the sake of convenience, FIG. 6 is the side view of the tuner unit 1D as viewed from the longitudinal side wall 311a side, the tuner unit 1D on the opposite side is similarly configured in a mirror-image relation.

As illustrated in FIG. 6, the portion in the first area of each of the longitudinal side walls 318a, 318b includes the through window 318c. An end of the through window 318c overlaps the boundary between the first area Ar1 and the second area Ar2. Further, an end portion on the first area Ar1 side of a leg portion 313c conforms to the end portion on the second area Ar2 side of the through window 318c (indicated by a dash-dotted line L1 of FIG. 6). In other words, the end on the second area Ar2 side of the through window 318c and the end on the first area Ar1 side of the leg portion 313c are aligned on the dash-dotted line L1.

The leg portions 313c are formed on the longitudinal side walls 318a, 318b, respectively, and hence the heat of the ICs 21 and transferred to the longitudinal side walls 318a, 318b is conducted to the main board MB through the leg portions 313c. Further, owing to provision of the through windows 318c, the longitudinal side walls 318a, 318b have high thermal resistance in the first area Ar1. Thus, the heat transferred from the ICs 21 to the longitudinal side walls 318a, 318b is more likely to be conducted to the main board MB through the leg portions 313c with low thermal resistance via the longitudinal side walls 318a, 318b arranged in the first area Ar1. With this configuration, the heat transferred from the ICs 21 to the longitudinal side walls 318a, 318b is conducted in a distributed manner to the main board MB through the leg portions 313c. The heat of the longitudinal side walls 318a, 318b is less likely to be conducted to the flat plate portion 314. Accordingly, the heat is less likely to be conducted also to the antenna input terminal 4 fixed onto the flat plate portion 314, and thus a temperature of the antenna input terminal 4 is less likely to rise.

According to the above description, the tip of the antenna input terminal 4 exposed from the rear cabinet Rc to the outside is less likely to reach high temperature. Owing to this, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4. Further, the leg portions 313c are arranged in the vicinities of the through windows 318c, and hence it is possible to ensure the strength of the longitudinal side walls 318a, 318b even with the through windows 318c.

Note that, though, in the tuner unit 1D, the end on the second area Ar2 side of the through window 318c and the end on the first area Ar1 side of the leg portion 313c are aligned with each other, the present invention is not limited thereto. That is, the through window 318c and the leg portion 313c may be arranged one above the other, or may be shifted so as not to be arranged one above the other. As a position of each of the through window 318c and the leg portion 313c, there may be widely adopted a position at which a heat conduction to the antenna input terminal 4 is small while maintaining the strength of the shield case 31. Note that, in order to efficiently suppress the heat conduction amount while maintaining the strength, it is preferred that the leg portion 313c be situated on the boundary between the first area Ar1 and the second area Ar2 or in the vicinity of the boundary.

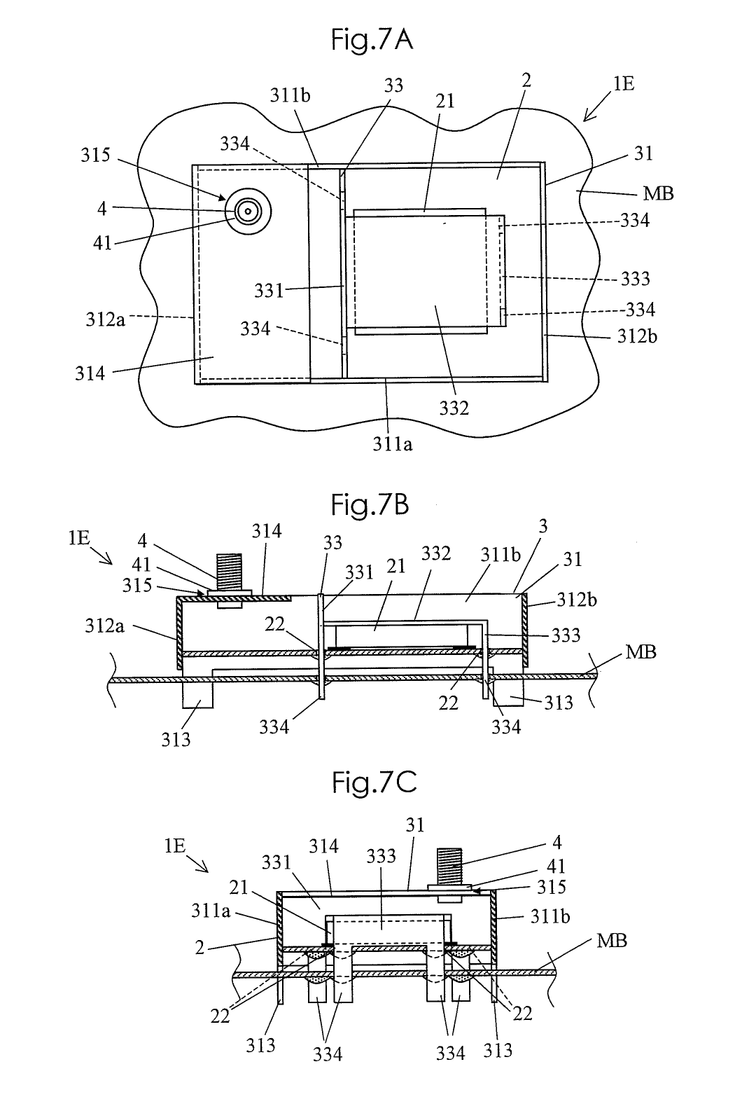

A tuner unit according to still another embodiment of the present invention is described with reference to the drawings. FIG. 7A is a plan view of the tuner unit according to the still another embodiment of the present invention. FIG. 7B is a sectional front view of the tuner unit according to the still another embodiment of the present invention. FIG. 7C is a sectional side view of the tuner unit according to the still another embodiment of the present invention. As illustrated in FIGS. 7A, 7B, and 7C, a tuner unit 1E has the same configuration as that of the tuner unit 1 except for including a partition member 33. Substantially the same portions of the tuner unit 1E as those of the tuner unit 1 are denoted by the same symbols. Further, detailed description of substantially the same portions of the tuner unit 1E as those of the tuner unit 1 is omitted.

The tuner unit 1E includes the partition member 33 instead of the partition member 32. Similarly to the partition member 32, the partition member 33 partitions the region surrounded by the longitudinal side walls 311a, 311b and the lateral side walls 312a, 312b of the shield case 31. The partition member 33 is formed by cutting and bending a metal plate by machining such as press working. The partition member 33 includes a partition portion 331 which partitions the region, a heat transfer plate 332 which is coupled to the partition portion 331 and to which the heat of the IC 21 is conducted, and a support portion 333 which is coupled integrally with the heat transfer plate 332, for supporting the heat transfer plate 332.

The partition portion 331 has a shape similar to the shape of the partition member 32, and is a rectangular plate-like member. Similarly to the partition member 32, the partition portion 331 includes protruding portions (not shown) at both end portions thereof, respectively. The protruding portions of the partition portion 331 are fitted into the openings (not shown) provided in the longitudinal side walls 311a, 311b, and are caulked so that the partition portion 331 is fixed. Further, the partition portion 331 includes, at a lower end portion thereof, two leg pieces 334 protruding downward.

The heat transfer plate 332 has a rectangular plate shape, and one end in the longitudinal direction of the heat transfer plate 332 is integrated with the partition portion 331. Further, the heat transfer plate 332 is fixed so as to be held in direct contact with a package of the IC 21. The support portion 333 is integrated with an end not connected to the partition portion 331, of ends in the longitudinal direction of the heat transfer plate 332. Specifically, the support portion 333 is formed by bending the end of the heat transfer plate 332 on an opposite side of the partition portion 331. Similarly to the partition portion 331, the support portion 333 also includes two leg pieces 334 at a lower end portion thereof.

The leg pieces 334 pass through through-holes (slits) 22 of the circuit board 2, and are soldered into the main board MB. Further, the leg pieces 334 and the circuit board 2 are also soldered to each other. The partition member 33 is fixed to the circuit board 2 and the main board MB, and is electrically connected to the wiring pattern provided to each of the circuit board 2 and the main board MB. Note that, the leg pieces 334 are connected to ground wiring of the wiring pattern of each of the circuit board 2 and the main board MB.

Owing to fixation of the partition member 33, the heat by driving of the IC 21 is conducted to the heat transfer plate 332 that is arranged to be held in contact with the IC 21. In this case, the partition member 33 is made of metal, and hence the thermal resistance from the IC 21 to the heat transfer plate 332 is lower than the thermal resistance from the IC 21 to the air. Thus, most of the heat of the IC 21 is conducted to the heat transfer plate 332. The heat conducted to the heat transfer plate 332 is conducted to the partition portion 331 and the support portion 333, and is conducted to the main board MB through the leg pieces 334.

The partition portion 331 is provided as described above, and hence it is possible to reduce, to a large extent, the heat conducted from the IC 21 to the longitudinal side walls 311a, 311b and the lateral side wall 312b through the atmosphere (air). As a result, the heat conducted to the flat plate portion 314 is reduced, and the heat is less likely to be conducted also to the antenna input terminal 4 fixed onto the flat plate portion 314. According to the above description, the tip of the antenna input terminal 4 exposed from the rear cabinet Rc to the outside is less likely to reach high temperature. Owing to this, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

Note that, between the IC 21 and the heat transfer plate 332, there may be interposed a heat transfer member, such as heat transfer grease or heat transfer gel, for increasing thermal conductivity therebetween. When the heat transfer member described above is interposed, in comparison with a case where the heat transfer member is not arranged, the heat of the IC 21 is more likely to be conducted to the heat transfer plate 332, and thus it is possible to reduce the heat conducted to the antenna input terminal 4. In the above description, in the partition member 33 illustrated in FIGS. 7A to 7C, the two leg pieces 334 protrude from each of the partition portion 331 and the support portion 333, and all of the leg pieces 334 are soldered to the circuit board 2 and the main board MB. However, the partition member 33 is not limited thereto. The number of the leg pieces 334 only needs to be large enough to reliably and stably fix the partition member 33 to the circuit board 2 and the main board MB. Even soldering may be omitted if it is possible to reliably and stably fix the partition member 33 without soldering and it is unnecessary to electrically connect the leg pieces 334 to the circuit board 2 and the main board MB.

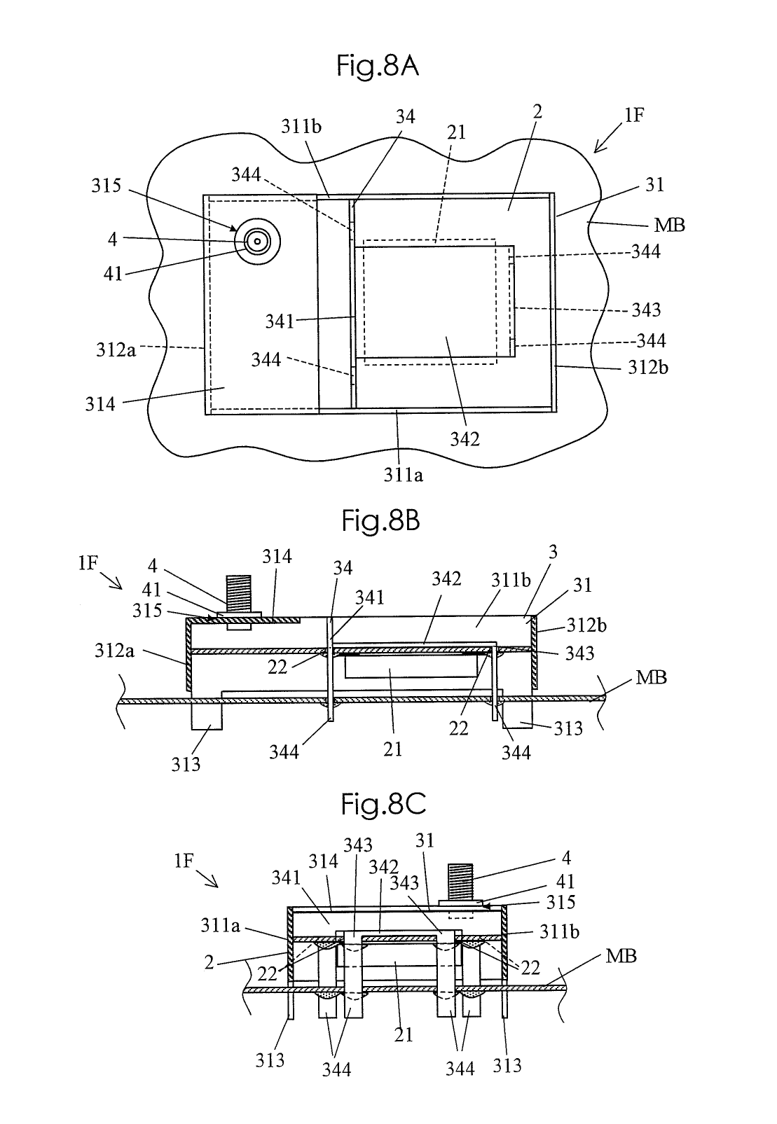

A tuner unit according to still another embodiment of the present invention is described with reference to the drawings. FIG. 8A is a plan view of the tuner unit according to the still another embodiment of the present invention. FIG. 8B is a sectional front view of the tuner unit according to the still another embodiment of the present invention. FIG. 8C is a sectional side view of the tuner unit according to the still another embodiment of the present invention. As illustrated in FIGS. 8A, 8B, and 8C, a tuner unit 1F has the same configuration as that of the tuner unit 1E illustrated in FIG. 7A except that the IC 21 is fixed on the circuit board 2 at a different position and a different partition member 34 is provided. Substantially the same portions of the tuner unit 1F as those of the tuner unit 1E are denoted by the same symbols. Further, detailed description of substantially the same portions of the tuner unit 1F as those of the tuner unit 1E is omitted. As illustrated in FIGS. 8A, 8B, and 8C, in a case of the circuit board 2, the IC 21 is fixed on the wiring pattern side, that is, on a side (lower side in FIGS. 8A, 8B, and 8C) on which soldering is performed.

As illustrated in FIGS. 8A, 8B, and 8C, a partition member 34 is formed by cutting and bending a metal plate by machining such as press working. The partition member 34 includes a partition portion 341 which partitions a region formed above each of the boards, a heat transfer plate 342 which is coupled to the partition portion 341 and to which the heat of the IC 21 is conducted, and a support portion 343 which is coupled integrally with the heat transfer plate 342, for supporting the heat transfer plate 342.

The partition portion 341 has a shape similar to the shape of the partition member 32, and is a rectangular plate-like member. Similarly to the partition member 32, the partition portion 341 includes protruding portions (not shown) at both ends thereof, respectively. The protruding portions of the partition portion 341 are fitted into the openings (not shown) provided in the longitudinal side walls 311a, 311b, and are caulked so that the partition portion 341 is fixed. Further, the partition portion 341 includes, at a lower end thereof, two leg pieces 344 protruding downward.

The heat transfer plate 342 has a rectangular plate shape, and one end in the longitudinal direction of the heat transfer plate 342 is integrated with the partition portion 341. Further, the heat transfer plate 342 is fixed so as to be held in contact with a surface of the circuit board 2 opposite to the portion of the circuit board 2 mounted with the IC 21. The support portion 343 is integrally connected with an end not connected to the partition portion 341, of ends in the longitudinal direction of the heat transfer plate 342. Specifically, the support portion 343 is formed by bending the end of the heat transfer plate 342 on an opposite side of the partition portion 341. Similarly to the partition portion 341, the support portion 343 also includes two leg pieces 344 at a lower end thereof.

The leg pieces 344 pass through the through-holes (slits) 22 of the circuit board 2, and are soldered into the main board MB. Further, the leg pieces 344 and the circuit board 2 are also soldered to each other. Thus, the partition member 34 is fixed to the circuit board 2 and the main board MB, and is electrically connected to the wiring pattern provided to each of the circuit board 2 and the main board MB. Note that, the leg pieces 344 are connected to ground wiring of the wiring pattern of each of the circuit board 2 and the main board MB.

The heat by driving of the IC 21 is conducted to the circuit board 2 held in contact with the IC 21, and is conducted to the heat transfer plate 342 arranged to be held in contact with a surface of the circuit board 2 opposite to a portion of the circuit board 2 mounted with the IC 21. The heat conducted to the heat transfer plate 342 is conducted to the partition portion 341 and the support portion 343, and is conducted to the main board MB through the leg pieces 344.

The partition portion 341 is provided as described above, and hence it is possible to reduce the heat transferred from the IC 21 to the longitudinal side walls 311a, 311b and the lateral side wall 312b through the atmosphere (air), and to reduce the amount of heat conducted to the flat plate portion 314. With the above-mentioned configuration, the heat generated from the electric circuit (in particular, IC 21) is less likely to be conducted to the antenna input terminal 4, and the portion of the antenna input terminal 4 exposed to the outside from the rear cabinet Rc is less likely to reach high temperature. As a result, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

Note that, the circuit board 2 is made of a resin (or material obtained by hardening a base material such as paper or glass with a resin) having thermal resistance higher than that of metal. Thus, the thermal resistance from the IC 21 to the heat transfer plate 342 becomes higher, whereas the heat conducted from the IC 21 to the heat transfer plate 342 becomes smaller. As the heat conducted from the IC 21 to the heat transfer plate 342 becomes smaller, the larger heat is transferred into the air. However, the IC 21 is fixed on the main board MB side (lower side in FIGS. 8A to 8C), that is, on a side opposite to the antenna input terminal 4 while the circuit board 2 is interposed between the IC 21 and the antenna input terminal 4. Thus, the heat is less likely to be transferred to the flat plate portion 314 side, and it is possible to suppress heat transfer to the flat plate portion 314.

Further, the heat transfer plate 342 is not held in direct contact with the IC 21, and hence it is possible to suppress an initial pressing force of the heat transfer plate 342 and a pressing force generated through deformation of the circuit board 2 and (or) the partition member 34 due to heat from being largely applied against the IC 21. By suppressing the forces applied to the IC 21, it is possible to prevent troubles such as the failure and breakage of the IC 21. In addition, the circuit board 2 is interposed between a connection terminal of the IC 21 and the heat transfer plate 342, and hence foreign matters do not enter therebetween, or the connection terminal and the heat transfer plate 342 are not held in contact with each other due to deformation. Thus, it is possible to prevent the terminal from being short-circuited, to thereby prevent troubles such as the malfunction, failure, and breakage of the IC 21 from occurring.

In the above description, in the partition member 34 illustrated in FIGS. 8A to 8C, the two leg pieces 344 protrude from each of the partition portion 341 and the support portion 343, and all of the leg pieces 344 are soldered to the circuit board 2 and the main board MB. However, the partition member 34 is not limited thereto. That is, the number of the leg pieces 344 only needs to be large enough to reliably and stably fix the partition member 34 to the circuit board 2 and the main board MB. Even soldering may be omitted if it is possible to reliably and stably fix the partition member 34 without soldering and it is unnecessary to electrically connect the leg pieces 344 to the circuit board 2 and the main board MB.

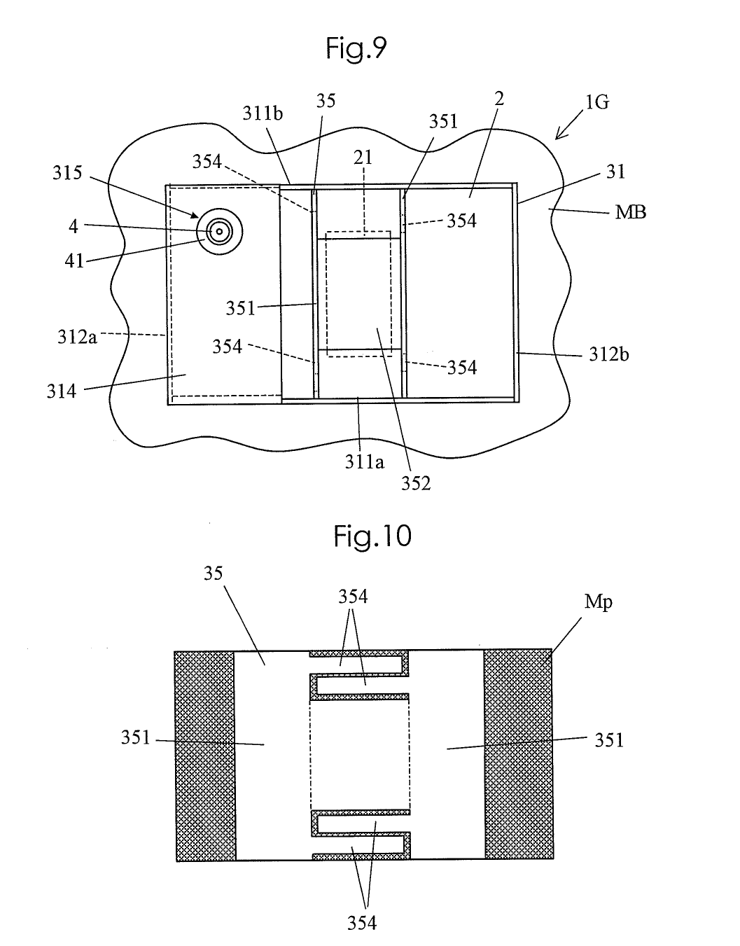

A tuner unit according to still another embodiment of the present invention is described with reference to the drawings. FIG. 9 is an enlarged view of a periphery of a partition member of the tuner unit according to the present invention. FIG. 10 is a view Illustrating cutting lines and bending lines at the time of cutting a metal plate before manufacturing the partition member. As illustrated in FIG. 9, a partition member 35 used for a tuner unit 1G includes two partition portions 351, 351 which are formed integrally with both end portions in the longitudinal direction of a rectangular heat transfer plate 352, respectively.

The partition portions 351, 351 have rectangular shape. The partition portions 351, 351 are formed by bending the heat transfer plate 352 toward one surface of the heat transfer plate 352, and are parallel to each other. Each of the partition portions 351, 351 is provided with two leg pieces 354. The leg pieces 354 protrude opposite to the partition portions 351 of the heat transfer plate 352.

The heat transfer plate 352 is arranged so as to be held in contact with a back surface of the portion of the circuit board 2 mounted with the IC 21. The leg pieces 354 pass through the through-holes (slits) provided in the circuit board 2 and the main board MB. Further, the leg pieces 354 are fixed by soldering to the ground wiring of each of the circuit board 2 and the main board MB.

As described above, with use of the partition member 35 including the partition portions 351, 351 formed integrally with the both ends of the heat transfer plate 352, it is possible to appropriately partition off the electric circuit including the IC 21 even in a configuration of the circuit board 2 in which the partition portions are not allowed to be satisfactorily apart from each other with respect to the length of the IC 21.

Note that, in the partition member 35 illustrated in FIG. 9, the heat transfer plate 352 is held in contact with the surface of the circuit board 2 opposite to the surface thereof mounted with the IC 21. However, similarly to the heat transfer plate 332 illustrated in FIGS. 7A to 7C, the heat transfer plate 352 may be held in direct contact with the IC 21.

FIG. 10 illustrates a metal plate Mp before the partition member 35 is manufactured. Note that, in FIG. 10, the cutting lines are indicated by solid lines, whereas the bending lines are indicated by broken lines. A portion corresponding to the rectangular heat transfer plate 352 is arranged at a center portion of the flat metal plate Mp. Portions corresponding to the partition portions 351 are respectively arranged at both ends of the heat transfer plate 352 so that the longitudinal direction of the partition portion 351 crosses (is orthogonal in FIG. 10) to the longitudinal direction of the heat transfer plate 352. Further, the metal plate Mp includes portions corresponding to the leg pieces 354, which extend toward each other from the portions corresponding to the respective partition portions 351. At this time, the portions corresponding to the leg pieces 354 are arranged in a staggered manner.

The metal plate Mp is cut along the solid lines, and hatched portions are removed. Further, the metal plate Mp is bent along the bending lines (to a near side of a paper face in FIG. 10) so that the portions corresponding to the partition portions 351 are raised with respect to the heat transfer plate 352. In this manner, the leg pieces 354 formed integrally with the partition portions 351 protrude to a side (deep side of a paper face in FIG. 10) opposite to the partition portions 351 while the heat transfer plate 352 is interposed between the leg pieces 354 and the partition portions 351, and thus the partition member 35 illustrated in FIG. 9 is manufactured. A residual material remaining after manufacture of the shield case 31 is assumed to be used as a material of the metal plate Mp. However, the material of the metal plate Mp is not limited thereto.

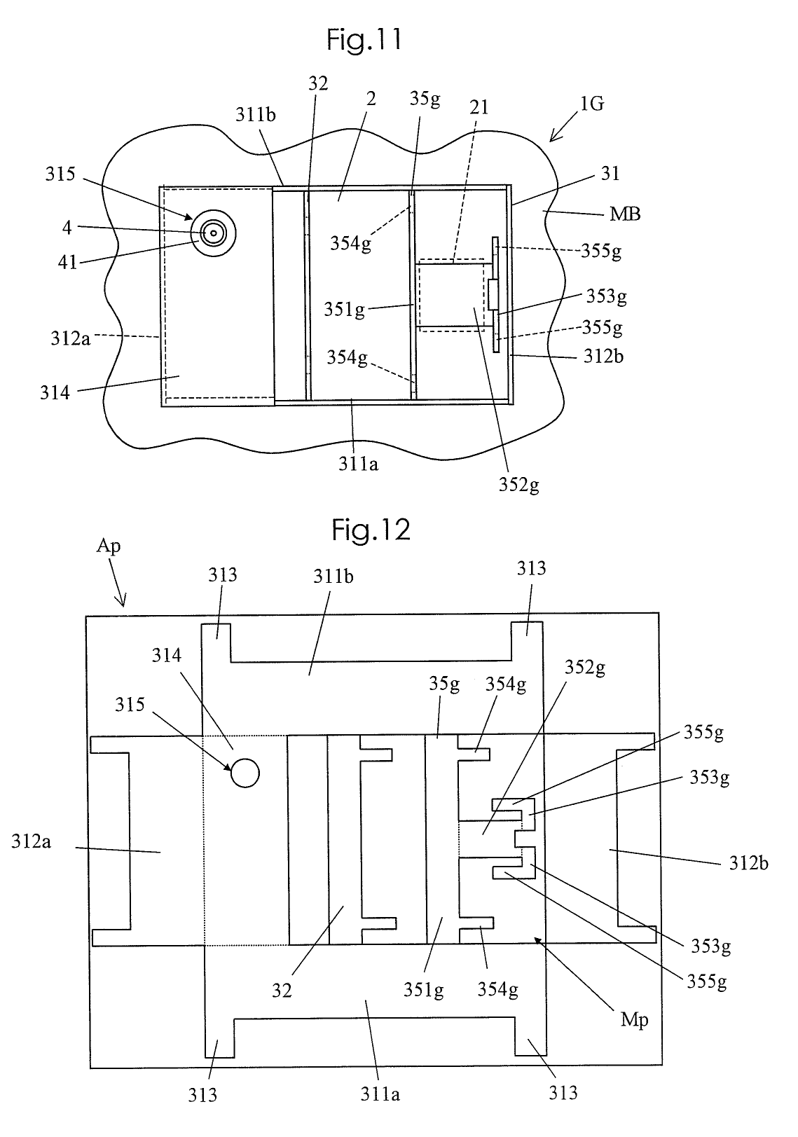

The partition member 35 illustrated in FIG. 9 includes the two partition portions 351 with the heat transfer plate 352 being interposed therebetween. However, the partition member 35 is not limited thereto. For example, in a case of a board in which the IC 21 is mounted in a vicinity of the lateral side wall 312b, it is possible to use the lateral side wall 312b in place of one of the partition portions 351, and to omit any one of the partition portions 351. In the following, a partition member in which any one of the partition portions 351 serves as a support portion 353 is described with reference to the drawings. FIG. 11 is an enlarged view of a periphery of the partition member of the tuner unit according to the present invention. FIG. 12 is a view illustrating cutting lines and bending lines drawn on a surface of a metal plate in order to manufacture the partition member. Note that, in FIG. 12, the cutting lines and the bending lines are indicated by solid lines and broken lines, respectively.

A partition member 35g illustrated in FIG. 11 includes a partition portion 351g which partitions a region formed above the board, a rectangular heat transfer plate 352g which is coupled to the partition portion 351g at one end in the longitudinal direction thereof, and a support portion 353g which is coupled integrally with the other end in the longitudinal direction of the heat transfer plate 352g. The partition member 35g is formed by cutting and bending a metal plate, and the partition portion 351g and the support portion 353g are formed by being bent to the same side with respect to the heat transfer plate 352g.

The partition portion 351g includes two leg pieces 354g, and the support portion 353g includes two leg pieces 355g. The leg pieces 354g and the leg pieces 355g protrude opposite to the bending direction with respect to the heat transfer plate 352g. Manufacture of the partition member 35g is described with reference to FIG. 12.

As illustrated in FIG. 12, a metal plate Ap is a metal plate in a state before manufacture of a shield section. The metal plate Ap is cut and bent by press working so that the shield case 31, the partition member 32, and the partition member 35g are manufactured. By cutting and bending a portion of the metal plate Ap other than the shield case 31, that is, a portion of a metal plate Mp surrounded by the longitudinal side walls 311a, 311b, the lateral side wall 312b, and the flat plate portion 314, the partition member 32 and the partition member 35g are formed.

Regarding the partition member 35g, the support portion 353g protrudes in the longitudinal direction of the heat transfer plate 352g in the metal plate Mp. The leg pieces 355g protrude from the support portion 353g toward the partition portion 351g. Further, as illustrated in FIG. 11, the leg pieces 355g are bent in the same direction as the partition portion 351g with respect to the heat transfer plate 352g, and thus the leg pieces 355g protrude opposite to the support portion 353g. The leg pieces 355g protrude toward the partition portion 351g, and hence it is possible to shorten a length of the partition member 35g before the partition portion 351g and the support portion 353g are bent. With this, even in a case where a plurality of partition members are necessary and an interval between the partition members is not allowed to be long in the metal plate Mp, it is possible to manufacture the partition member 35g including the heat transfer plate 352g.

A tuner unit according to still another embodiment of the present invention is described with reference to the drawings. FIG. 13 is a sectional view of the tuner unit according to still another embodiment of the present invention. The shield section 3 of a tuner unit 1H illustrated in FIG. 13 is attached with a shield cover 36 for covering an opening of the shield case 31. Note that, the tuner unit 1H has the same configuration as that of the tuner unit 1 illustrated in FIG. 2 or the like except for being attached with the shield cover 36. Substantially the same portions of the tuner unit 1H as those of the tuner unit 1 are denoted by the same symbols. Further, detailed description of substantially the same portions of the tuner unit 1H as those of the tuner unit 1 is omitted.

The shield cover 36 covers the opening of the shield case 31. The shield cover 36 includes a first cover member 361 attached on the main board MB side, and a second cover member 362 attached on the antenna input terminal 4 side. Note that, the second cover member 362 has an opening formed in a portion overlapping the flat plate portion 314, and is not held in direct contact with the antenna input terminal 4.

Similarly to the shield case 31, each of the first cover member 361 and the second cover member 362 is a lid-like member formed by cutting and bending a metal plate by press working. The shield cover 36 is electrically connected to the shield case 31 and is fixed thereto. The circuit board 2 is covered with the shield case 31 and the shield cover 36, and is magnetically shielded. Fixation of the shield case 31 and the shield cover 36 may be performed using a well-known conventional method, i.e., a method capable of performing easy and tight fixation such as a fixing method of fit-engaging the protrusion into the opening or of fit-engaging with a screw. Here, fit-engaging with a screw is performed.

The first cover member 361 includes a contact portion 363 formed by cutting and bending the first cover member 361 at a position opposed to the IC 21. The contact portion 363 is formed into a rectangular flat plate at a leading edge thereof, and includes a heat transfer portion 364 brought into contact with the IC 21, and a coupling portion 365 coupling the heat transfer portion 364 and the first cover member 361 together. The contact portion 363 presses the heat transfer portion 364 against the IC 21 by an elastic force of the coupling portion 365. Further, the first cover member 361 includes, in a vicinity of the coupling portion 365, a connection portion 366 to be connected to the main board MB. The connection portion 366 is bent opposite to the contact portion 363 to pass through the main board MB, and is fixed to the main board MB by soldering.

The heat of the IC 21 is conducted to the first cover member 361 through the heat transfer portion 364. Further, the conducted heat is conducted to the main board MB through the connection portion 366. The contact portion 363 and the connection portion 366 are provided to the first cover member 361 of the shield cover 36 as described above, and hence it is possible to reduce the heat transferred from the IC 21 to the longitudinal side walls 311a, 311b and the lateral side wall 312b through the atmosphere (air), and to reduce the heat conducted to the flat plate portion 314. With the above-mentioned configuration, the heat of the electric circuit (in particular, IC 21) is less likely to be conducted to the antenna input terminal 4. Further, the tip of the antenna input terminal 4 protruding from the rear cabinet Rc is less likely to reach high temperature. Thus, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

Note that, in a case where the IC 21 is mounted on the circuit board 2 on an opposite side of the main board MB, the contact portion 363 may be arranged so as to be held in contact with a back side of the portion of the circuit board 2 on which the IC 21 is mounted. It goes without saying that, in a case where a terminal of a member mounted on the circuit board 2 protrudes from the board (through-hole mount), the contact portion 363 is arranged so as not to be held in direct contact with the terminal and the wiring pattern.

Note that, though only the tuner unit 111 described in this embodiment has the configuration attached with the shield cover 36, the present invention is not limited thereto. Also in the other embodiments described above, a shield cover having a configuration capable of closing the opening may be attached as needed.

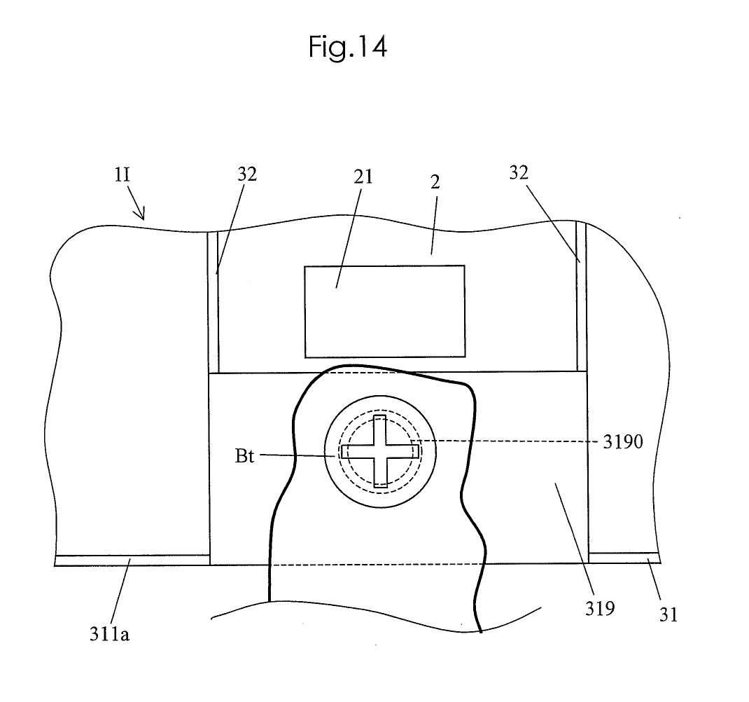

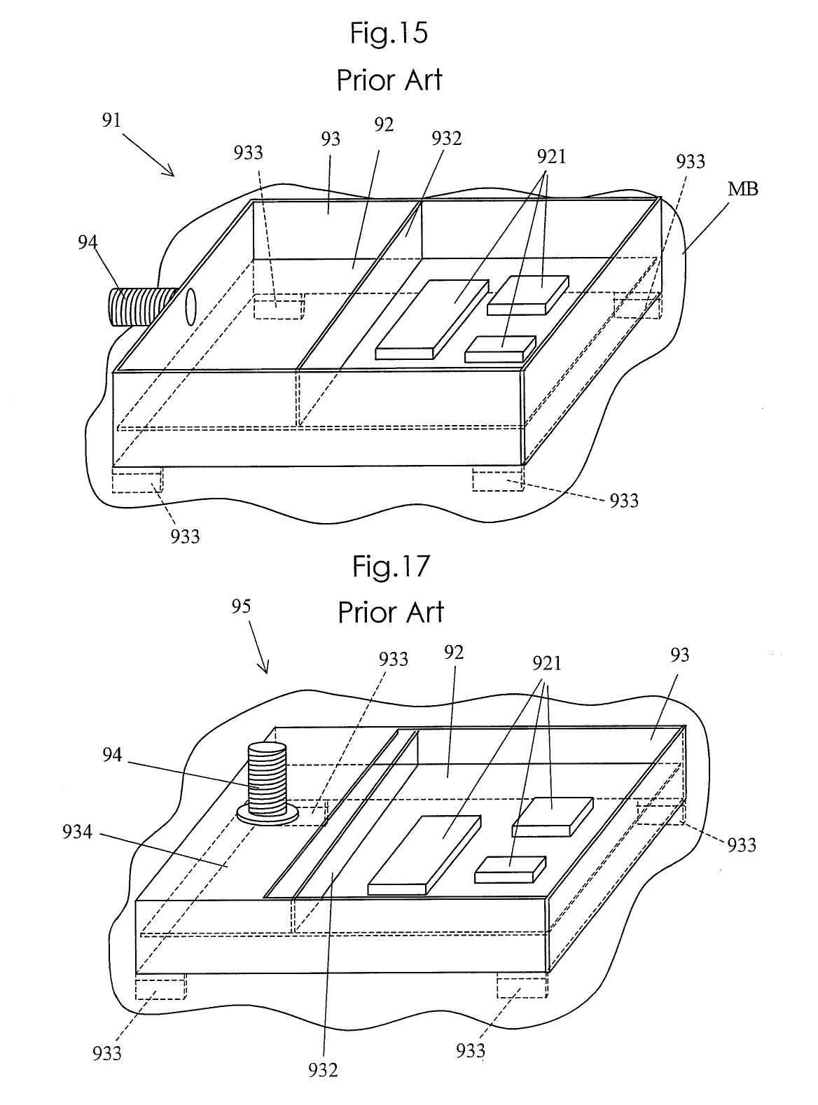

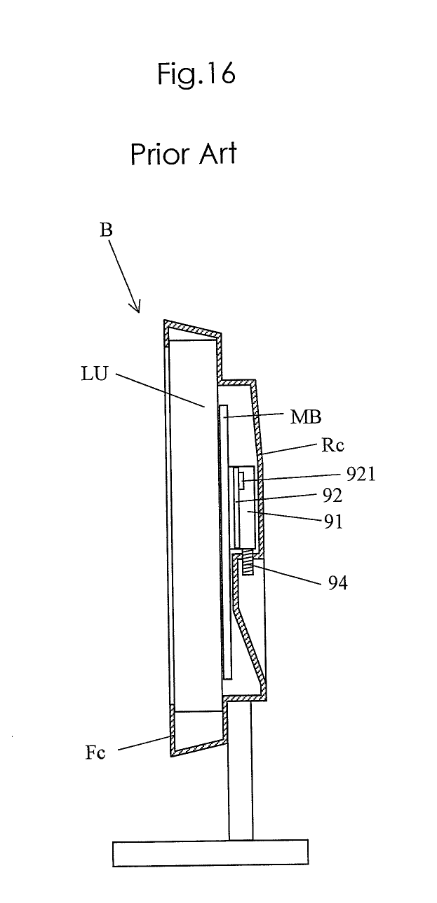

A tuner unit according to still another embodiment of the present invention is described with reference to the drawings. FIG. 14 is a plan view of the tuner unit according to the still another embodiment of the present invention. A tuner unit 1I illustrated in FIG. 14 includes a flat portion 319 that is arranged to be held in contact with the longitudinal side wall 311a and the partition members 32. The flat portion 319 is integrated with the partition members 32 for partitioning off a region in which the IC 21 having the large heat is mounted. As illustrated in FIG. 14, the flat portion 319 has a rectangular shape, and the partition members 32 are provided at both ends in the longitudinal direction of the flat portion 319, respectively. Further, the flat portion 319 includes, at a center thereof, a tapped screw hole 3190 formed therein. By fixing a metal heat radiation portion formed in a frame or the like into the screw hole with a screw, it is possible to conduct the heat through a screw Bt, and it is possible that the heat is less likely to be conducted to the flat plate portion 314.

According to the above description, the heat of the electric circuit (in particular, IC 21) is less likely to be conducted to the antenna input terminal 4, and it is possible to inhibit the portion of the antenna input terminal 4 exposed to the outside from the rear cabinet from reaching high temperature. As a result, when part of the bodies (body) of a worker and (or) a user touch(es) the tip of the antenna input terminal 4, the worker and (or) the user are (is) less likely to feel discomfort and pain at the part of the bodies (body) touching the antenna input terminal 4.

In each of the above-mentioned embodiments, the antenna input terminal is adopted as an external connection terminal. However, the present invention is not limited thereto. A similar configuration is adopted even in a case of using a terminal having a tip exposed to the outside of a casing, and thus (tip of) the terminal is less likely to reach high temperature. Thus, when part of the bodies (body) of a worker and (or) a user touch(es) the tip of the terminal, the worker and (or) the user are (is) less likely to feel discomfort and pain at the part of the bodies (body) touching the terminal.

Description of the embodiments is made for describing the present invention, but does not limit the invention described in the claims or does not restrict the scope of the present invention. It is needless to say that each component of the present invention is not limited to one described in the above-mentioned embodiments and various modifications are possible within a technical range described in the claims.

The present invention is applicable to a tuner unit that is mounted on a flat-screen television receiver using the LCDP, the PDP, or the like.

1. A tuner unit, comprising:
a circuit board on which an electronic component is mounted;
a shield case comprising
a plurality of side walls surrounding the circuit board, and
a flat plate portion that is integrated with at least one of the plurality of side walls and is arranged to be opposed to the circuit board; and
an external connection terminal fixed to the flat plate portion,
wherein the shield case comprises a first area, in which the flat plate portion is arranged, and a second area surrounding a portion of the circuit board mounted with the electronic component.

2. A tuner unit according to claim 1, wherein the flat plate portion comprises an external connection terminal fixing portion including at least three projections that are held in contact with the external connection terminal.

3. A tuner unit according to claim 1, wherein the shield case comprises a plurality of leg portions that are formed on the plurality of side walls to be connected to an external board, and has a structure in which more leg portions are situated in the second area than in the first area.

4. A tuner unit according to claim 1, wherein the shield case comprises a through window formed in at least one of the plurality of side walls over the first area and the second area.

5. A tuner unit according to claim 3, wherein:
the shield case comprises a through window formed in a portion in the first area of at least one of the plurality of side walls; and
at least one of the plurality of leg portions is formed in a vicinity of an end portion on a side of the second area of the through window.

6. A tuner unit according to claim 1, further comprising a partition member that is coupled to at least one of the plurality of side walls of the shield case and is arranged in a vicinity of the electronic component,
wherein the partition member comprises:
a partition portion for partitioning off a part, which contains the electronic component, of a portion of the circuit board surrounded by the plurality of side walls;
a heat transfer plate continuous with the partition portion, for covering a surface of the electronic component while being held in contact with the surface of the electronic component;
a support portion continuous with an opposite side of a portion of the heat transfer plate continuous with the partition portion, for supporting the heat transfer plate; and
leg pieces that protrude on an end portion of the partition portion and an end portion of the support portion, respectively, protrude from a surface of the circuit board opposite to a surface of the circuit board mounted with the electronic component, and are soldered to an external board.

7. A tuner unit according to claim 1, further comprising a partition member that is coupled to at least one of the plurality of side walls of the shield case and is arranged in a vicinity of the electronic component,
wherein the partition member comprises:
a partition portion for partitioning off a part, which contains the electronic component, of a portion of the circuit board surrounded by the plurality of side walls;
a heat transfer plate that is continuous with the partition portion, and is held in contact with a back side of the portion of the circuit board mounted with the electronic component;
a support portion continuous with an opposite side of a portion of the heat transfer plate continuous with the partition portion, for supporting the heat transfer plate; and
leg pieces that protrude on an end portion of the partition portion and an end portion of the support portion, respectively, protrude from a surface of the circuit board opposite to a surface of the circuit board mounted with the electronic component, and are soldered to an external board.

8. A tuner unit according to claim 1, further comprising a partition member that is coupled to at least one of the plurality of side walls of the shield case and is arranged in a vicinity of the electronic component,
wherein the partition member comprises:
a pair of partition portions for partitioning off a part, which contains the electronic component, of a portion of the circuit board surrounded by the plurality of side walls;
a heat transfer plate continuous with the pair of partition portions, for covering a surface of the electronic component while being held in contact with the surface of the electronic component; and
leg pieces that protrude on end portions of the pair of partition portions, respectively, protrude from a surface of the circuit board opposite to a surface of the circuit board mounted with the electronic component, and are soldered to an external board.

9. A tuner unit according to claim 1, further comprising a partition member that is coupled to at least one of the plurality of side walls of the shield case and is arranged in a vicinity of the electronic component,
wherein the partition member comprises:
a pair of partition portions for partitioning off a part, which contains the electronic component, of a portion of the circuit board surrounded by the plurality of side walls;
a heat transfer plate that is continuous with the pair of partition portions, and is held in contact with a back surface of the portion of the circuit board mounted with the electronic component; and
leg pieces that protrude on end portions of the pair of partition portions, respectively, protrude from a surface of the circuit board opposite to a surface of the circuit board mounted with the electronic component, and are soldered to an external board.

10. A tuner unit according to claim 6, wherein at least one of the leg pieces is soldered to the circuit board.

11. A tuner unit according to claim 1, further comprising a shield cover for covering both sides of a region surrounded by the plurality of side walls of the shield case, the shield cover comprising, on a side opposed to an external board, a contact portion formed by cutting and bending a middle portion of the shield cover,
wherein the contact portion comprises:
a heat transfer portion held in contact with a surface of the electronic component;
a coupling portion for coupling the heat transfer portion and the shield cover together; and
a connection portion that is arranged in a vicinity of the coupling portion and is connected to the external board.

12. A tuner unit according to claim 1, further comprising a shield cover for covering both sides of a region surrounded by the plurality of side walls of the shield case, the shield cover comprising, on a side opposed to an external board, a contact portion formed by cutting and bending a middle portion of the shield cover,
wherein the contact portion comprises:
a heat transfer portion held in contact with a back surface of the portion of the circuit board mounted with the electronic component;
a coupling portion for coupling the heat transfer portion and the shield cover together; and
a connection portion that is arranged in a vicinity of the coupling portion and is connected to the external board.

13. A tuner unit according to claim 1, wherein:
the shield case comprises, in a vicinity of the portion of the circuit board mounted with the electronic component, a flat portion arranged integrally with at least one of the plurality of side walls; and
the flat portion is spaced apart from the flat plate portion, and comprises a tapped screw hole.

14. A flat-screen television receiver, comprising the tuner unit according to claim 1.

15. A flat-screen television receiver, comprising the tuner unit according to claim 2.

16. A flat-screen television receiver, comprising the tuner unit according to claim 3.

17. A flat-screen television receiver, comprising the tuner unit according to claim 4.

18. A flat-screen television receiver, comprising the tuner unit according to claim 5.

19. A flat-screen television receiver, comprising the tuner unit according to claim 6.

20. A flat-screen television receiver, comprising the tuner unit according to claim 7.
